(19) United States
(12) Patent Application Publication
(10) Pub. No.: US 2011/0012334 A1
(43) Pub. Date: Jan. 20, 2011

(54) VEHICLE FRAME

(76) Inventor: Mats Malmberg, Nassjo (SE)

Correspondence Address: MOORE & VAN ALLEN PLLC, P.O. BOX 13706, Research Triangle Park, NC, 27709, US

(21) Appl. No.: 12/668,153

(22) PCT Filed: Jul. 10, 2007
(86) PCT No.: PCT/SE2007/000670

§ 371 Date: Oct. 4, 2010

(51) Int. Cl. B62D 21/12; B21D 53/88

(52) U.S. Cl. 280/785; 29/897.2

(57) ABSTRACT

A vehicle frame for a vehicle (100) having at least two driven rear wheels or a wide rear drive roller or similar (snowmobile), the frame comprises a main frame portion (300) and an upper frame portion (200) as a load carrying unit. The upper frame portion is dismountable from the main frame portion (300) for providing access to the interior of the latter.

A method for manufacturing this kind of vehicle comprises the steps of:
1. manufacturing a main frame portion (300) of a vehicle frame;
2. installing an engine and a corresponding gearbox in the main frame portion (300) of the vehicle frame;
3. mounting an upper frame portion (200) to the main frame portion.

### FIELD OF THE INVENTION

The present invention relates to a vehicle frame for a vehicle, having at least two driven rear wheels or a wide rear drive roller or similar (snowmobile). It also relates to a manufacturing method facilitating the manufacturing of the vehicle, and to a saddle assembly constituting a load carrying unit in the vehicle frame of the present invention.

### BACKGROUND OF THE INVENTION

In recent years, all terrain vehicles (or ATV:s) have gained much appreciation for their ability to conquer bad terrain, their loading capacity and their robustness. They have also gained a reputation of being fun to drive, and ATV:s have found a large clientele using the vehicles for pleasure driving only. An ATV can be either four wheel drive or two wheel drive. There are also similar vehicles for street use. Usually an ATV or similar vehicle has four wheels, but conceivably it could also be a three wheeler having a single front wheel.

Until now, most ATV:s are constituted of a vehicle frame supporting an engine, at least one gearbox and a saddle. Usually it also has a CVT belt transmission and sometimes a centrifugal clutch. The engine, gearbox and possible CVT and centrifugal clutch forms a drive unit for the vehicle. The only load carrying member of the ATV is the vehicle frame, which, in order to be able to transfer the weight of a driver, the engine and the driveline to wheels of the vehicle, is more or less surrounding the engine and the gearbox. This does not only make the vehicle frame unnecessarily heavy and, hence, expensive, it also constitutes a major problem when it comes to the production process; the drive unit could not simply be put in place, instead it must be precisely fitted into a space delimited by the vehicle frame components. Often the drive unit is divided into several parts each individually fastened to the frame. For a four wheel drive vehicle normally one central part with engine, CVT and gearbox and a rear part with rear drive/rear differential and a front part with front differential.

The prior art vehicle frames also constitute a problem when it comes to servicing the engine and/or the gearbox, since the components of the vehicle frames are “in the way”. This is particularly true for a vehicle having four wheels or a snowmobile, with wide drive mat, because they need a wider frame than a motorcycle. The wider frame is much more “in the way”.

In conclusion, there is a need for a vehicle frame that is lighter than the prior art frames, and that allows an as full access as possible to the engine components.

### SUMMARY OF THE INVENTION

The present invention solves the above and other problems by providing a vehicle frame, wherein an upper portion of the vehicle frame can be dismounted from a main portion of the vehicle frame.

In one embodiment of the invention, the upper portion of the vehicle frame supports a saddle.

In order to prevent the vehicle frame according to the invention from rusting and corroding and to facilitate joining of frame members to one another, the main portion can be manufactured from stainless steel pipes having a square section. Also the upper portion can be manufactured from stainless steel.

The vehicle frame according to invention allows a new and innovative manufacturing method for the entire vehicle to be used. The method for manufacturing an all terrain vehicle includes the steps of:
i. manufacturing a main portion and an upper frame portion of a vehicle frame;
ii. installing an engine and a corresponding gearbox in the main portion of the vehicle frame; and
iii. mounting an upper frame portion to the main frame portion.
   In order to further utilize combination benefits, a saddle could constitute the upper frame portion.

### BRIEF DESCRIPTION OF THE DRAWINGS

In the following, the invention will be described with reference to the appended drawings, wherein:

FIG. 1 is an isometric view showing a four-wheel drive all terrain vehicle comprising a vehicle frame according to the invention,

FIG. 2 is a side view of the vehicle frame according to the invention,

FIG. 3 is a top view of the vehicle frame according to the invention,

FIG. 4 is a front view of the vehicle frame according to the invention,

FIG. 5 is an isometric view of the vehicle frame according to the invention and

FIG. 6 is an isometric view showing an upper, detachable frame portion constituting a part of the vehicle frame according to the present invention.

### DESCRIPTION OF EMBODIMENTS

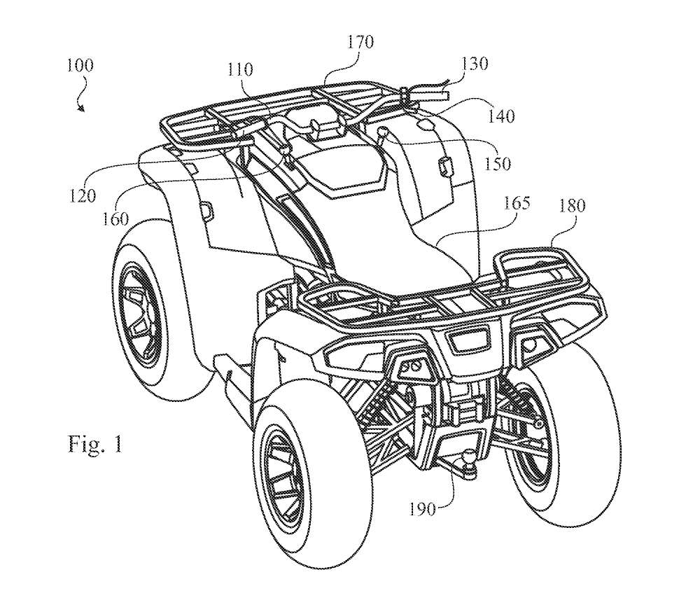

With reference to the drawings, FIG. 1 shows a four-wheel drive all terrain vehicle 100 (4WD ATV) of the type common for leisure and commercial use. It could however also be of a 2 WD design and possibly even have a single front wheel. The frame concept is also usable for a snowmobile having a wide rear drive roller, drive mat or similar, as this brings a wide frame. The vehicle 100 comprises a steering bar 110, including right and left handlebars 120 and 130. In the vicinity of the right handlebar, a throttle controller 140 is provided. The throttle controller is connected by wire (or by electronic means) to a throttle (not shown) of an engine (not shown). The vehicle 100 further comprises a first gear shift knob 150, with which a gearbox (not shown) is set into an appropriate gear; in one embodiment of the invention, the gearbox could be put into high gear (for high velocities), low gear (for low velocities, but lot of traction power), neutral (e.g. useful at engine cranking at startup) or parking (for providing a braking function).

A second gear shift knob 160 is provided at the left side of the vehicle, or at least such that it can be maneuvered by the left hand, and has the two possible positions of reverse and forwards; by controlling the reverse/forward function to a separate gear shift knob, rather than combining the reverse/forward function into the gearshift knob controlling high and low gear, it is possible to rapidly shift between forward and reverse drive, which could be useful if the vehicle has got stuck in the terrain.

The vehicle 100 as shown in FIG. 1 also comprises a saddle 165. Front and back package carriers 170 and 180, respectively are situated in front of, and behind the saddle 165. Such package holders might be very useful for some applications, and might be delivered as an add-on for a vehicle. The vehicle 100 of FIG. 1 also comprises a tow hook 190, which could be used to tow tow vehicles but also logs, fallen game, etc.

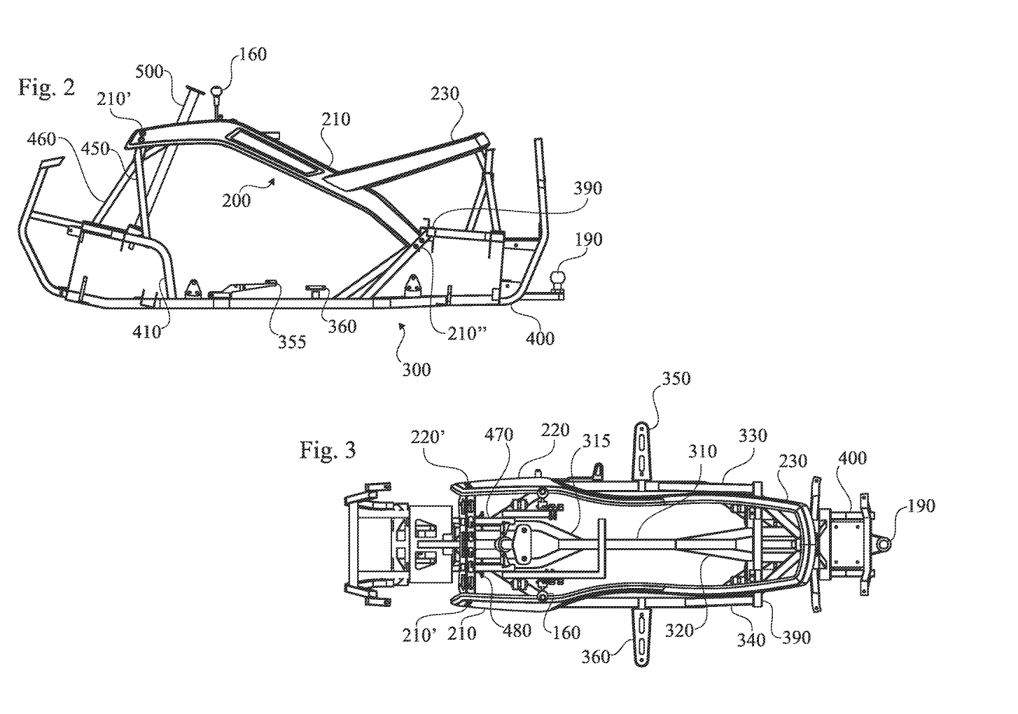

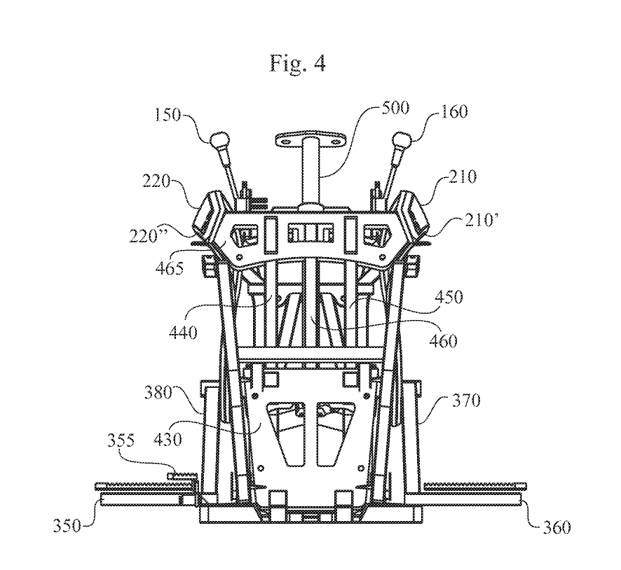

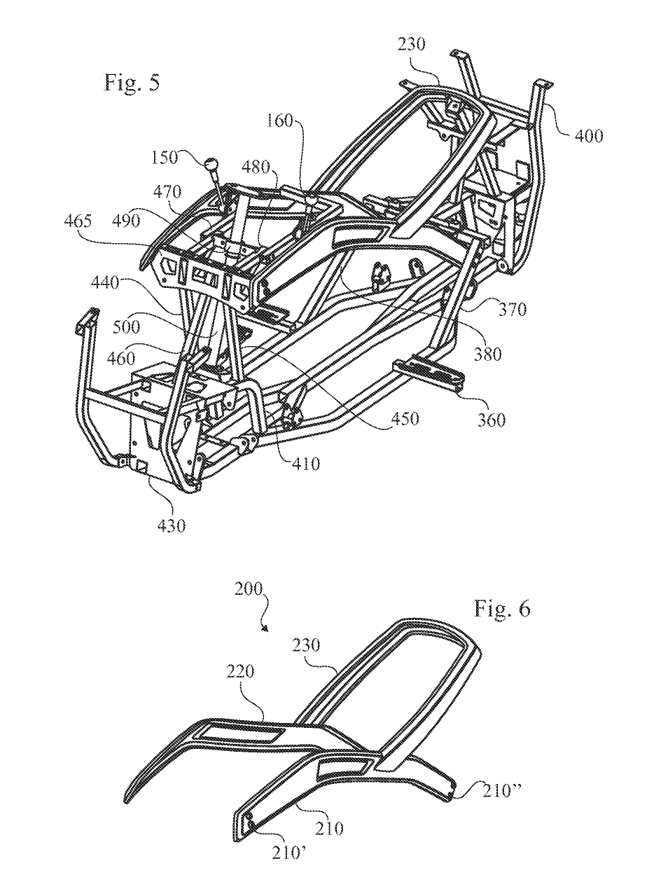

With reference to FIGS. 2, 3, 4, 5 and 6, the vehicle frame according to the invention comprises an upper frame portion 200 and a main frame portion 300.

The upper frame, or saddle, portion 200 comprises two mirrored elongate members 210, 220, which are fastened to the main frame 300 by bolt and nut assemblies 210′, 210″, 220′, 220″. The elongate members are joined by a saddle-suspension portion 230, which is a generally U-shaped member, the ends of which being joined to the two elongate members 210, 220. The saddle 165 is fastened to the saddle suspension portion 230 and to the two mirrored elongate members 210, 220.

The mirrored elongate members are bent to allow knee room for a driver straddling the saddle 165 (FIG. 1).

The main frame portion 300 comprises a double-forked central portion 310, which is provided with fork-like extensions 315, 320, extending in the forward and backward direction, respectively. Two side portions 330, 340 extend generally parallel to the central portion; the ends of the side portions 330, 340 are bent towards the forklike extensions 315, 320 and joined with them.

Two footrests 350, 360 are fastened to the side portions 330, 340, and a brake pedal 355 is fastened to the right side portion 330 just in front of the footrest 350. The footrests could be covered with some kind of grip-enhancing means, e.g. a plate provided with an upwardly extending pattern of ridges and grooves.

Moreover, two backwardly inclined frame portions 370, 380 are fastened to the side portions 330, 340. The inclined frame portions 370, 380 are fastened to an intermediate frame portion 390; hence, there will be a firm lateral connection between the inclined frame portions 370, 380. Further, it could be noted that the elongate members 210, 220 are fastened to the inclined frame portions 370, 380.

The intermediate frame portion 390 and the ends of the forks 320 provide a suitable assembly for the mounting of a suspension frame 400, which e.g. could serve as a suspension for the tow hook 190, optional lamps and fenders or mudguards; the provision of such accessories is however optional, and could be omitted.

On a front portion of the side portions 330, 340, two first stanchions 410, 420 (only 410 shown) are fastened; the stanchions extend in a generally upward direction, and are bent forwards some distance above the side portions 330, 340. Above the bend, a plate 430 joins the first stanchions 410, 420. The plate is formed in an L-shape, and the long leg of the L extends from the first stanchions 410, 420 to the front fork-like extensions 315. This provides a firm connection between the fork-like extensions and the stanchions.

Two second stanchions 440, 450 extend upward from the L-shaped plate 430 and a further stanchion 460 extends from the short side of the L-shaped plate 430. All stanchions 440, 450,460 are fastened to a crossbar 465, preferably made from a plate formed into a U-shaped section. The use of a U-shaped plate provides a good lateral stability.

Two short frame portions 470, 480 extend backward from the crossbar 465. The frame portions 470 and 480 are joined by an upper steering column suspension 490, which forms an upper support for a steering column 500.

Moreover, the frame according to the invention comprises a multitude of eyelets and openings for wheel suspensions, engine mountings, etc.

One special feature of the frame according to the invention is that it is possible to split the frame, i.e. dismount the upper frame portion 200 for allowing a drive unit (not shown) to be mounted in the main frame portion 300. The splitting feature is very beneficial when it comes to mounting and servicing of the drive unit, since a removal of the upper frame portion (if desired, with the saddle (not shown)) gives a large free space around the drive unit.

In order to facilitate the removal of the upper frame portion 200, the bolt and nut assemblies 210′, 210″, 220′, 220″ could comprise a wing nut, which might allow the saddle and upper frame to be removed without the use of tools.

In one embodiment of the invention, the upper frame portion is manufactured from a pressed sheet metal of stainless steel, although other manufacturing methods, i.e. welding of plates, deep pressing, etc, could be used.

The main frame portion 300 is preferably made from stainless steel pipes, which have been bent to the desired shapes. In a preferred embodiment, the stainless steel pipes have a square section; a square shape facilitates joining of pipes. The joining between the pipes constituting the main frame portion 300 is preferably performed by welding, although other joining methods, e.g. riveting, soldering, brazing, etc could be used. It is also possible to use other metals, e.g. steel, as a material for the main frame portion 300. it is also possible to use pipes having other sections than square, e.g. an annular section.

The fastening of the saddle to the upper frame 200 enables the saddle to be very rigidly connected to the vehicle, since it is an unnecessary feature to be able to remove the saddle from the upper frame, due to the possibility to remove the entire upper frame from the main frame; this is a rare feature on most saddled vehicle, e.g. motorcycles, mopeds, snow mobiles and ATV:s, where it is possible to remove only the saddle. On such vehicles, the saddle constitutes nothing more than a comfortable seating place, meaning it is possible to ride the vehicle without the saddle, whereas the saddle according to the invention, when combined with the upper frame, constitutes a load bearing member of the vehicle frame according to the invention.

It could also be worth mentioning something about the engine/gearbox design that is preferably used in combination with the vehicle frame according to the present invention; in a preferred embodiment of the invention, the engine and its associated gearboxes are built to form a single drive unit. This drive unit includes an engine driving a CVT driving a gear box. These parts are bolted together forming a long one piece drive unit that holds the engine in a forward end and a rear output drive for the rear wheels in the rearward end. The lateral drive shafts for the two rear wheels connect to the rear output drive. If the ATV is 2WD this is the complete drive unit. If the ATV is 4WD there is also a forward output drive in the lower part of the engine. To this a longitudinal shaft is connected and running to a forward differential housing for the drive of the front wheels. By this arrangement, it is possible to get a driveline that is “narrow”, i.e. that allows straddling without too much spreading of the legs of a user straddling the saddle and engine of the vehicle comprising the vehicle frame according to the present invention. Moreover, the drive unit, i.e. the engine/CVT/gearbox assembly will be longer than usual and will transfer forces to the vehicle frame in a more efficient way than a conventional drive assembly consisting of separate parts fastened to the frame. The long drive unit can even support the frame.

What is claimed is:

1. A vehicle frame for a vehicle, having at least two driven rear wheels or a wide rear drive roller or similar (snowmobile), characterized in that the vehicle frame comprises a main frame portion and an upper frame portion as a load carrying unit, the upper portion being dismountable from the main portion for providing access to an interior of the main portion.

2. The vehicle frame of claim 1, wherein the upper portion of the vehicle frame supports a saddle.

3. The vehicle frame of claim 1, wherein the main portion is manufactured from stainless steel pipes having a square section.

4. The vehicle frame of claim 1, wherein the upper portion is manufactured from stainless steel.

5. The vehicle frame of claim 4 wherein at least two elongate members of the upper portion are made from open sections of pressed stainless steel.

6. The vehicle frame of claim 4 wherein at least a saddle suspension portion of the upper portion is made from open sections of pressed stainless steel.

7. The vehicle frame of claim 6, wherein the open sections are formed in a U-shaped member.

8. The vehicle frame of claim 1, wherein the vehicle has four wheels.

9. A method for manufacturing a vehicle, comprising:
manufacturing a main frame portion of a vehicle frame;
installing an engine and a gearbox in the main frame portion of the vehicle frame; and
mounting an upper frame portion to the main frame portion, the upper frame portion being dismountable from the main portion for providing access to the engine and the gearbox.

10. The vehicle frame of claim 1 further comprising a saddle portion, wherein the saddle portion constitutes a load-carrying member of the vehicle frame.

11. A vehicle, comprising:
a vehicle frame, the vehicle frame comprising:
a main portion; and
an upper portion as a load carrying unit, the upper portion being dismountable from the main portion for providing access to an interior of the main portion.

12. The vehicle of claim 11, wherein the upper portion of the vehicle frame supports a saddle.

13. The vehicle of claim 11, wherein the main portion is manufactured from stainless steel pipes.

14. The vehicle of claim 11, wherein the upper portion is manufactured from stainless steel.

15. The vehicle of claim 11, wherein the upper portion comprises at least two elongate members.

16. The vehicle of claim 15, wherein the upper portion further comprises a saddle suspension portion.

17. The vehicle of claim 16, wherein the saddle suspension portion is generally U-shaped.

18. The vehicle of claim 11, wherein the vehicle comprises three wheels.

19. The vehicle of claim 11, wherein the vehicle comprises a rear drive roller.

20. The vehicle of claim 11, wherein the upper portion comprises:
two mirrored elongate members; and
a saddle suspension portion joined to the elongate members, the saddle suspension portion being generally U-shaped.
